(19) United States
(12) Patent Application Publication
(10) Pub. No.: US 2008/0247318 A1
(43) Pub. Date: Oct. 9, 2008

(54) Low cost method of communication via the power supply grid

(76) Inventor: Sitaramarao Srinivas Yechuri, Lake Forest, CA (US)

Correspondence Address: Sitaramarao Srinivas Yechuri, 203 Hamilton Ave, Apt 2D, Staten Island, NY, 10301, US

(21) Appl. No.: 11/784,586

(22) Filed: Apr. 9, 2007

(51) Int. Cl. H04J 3/14

(52) U.S. Cl. 370/238

(57) ABSTRACT

This invention describes a low cost method for electrical and electronic appliances to communicate with a master control appliance (such as a computer). It has often been said that very soon all appliances will be connected to the internet. However this is economically infeasible at this time. The minimum cost of adding ethernet connectivity to an appliance is approximately $100. For an appliance that costs less than $100 (and there are many) this is obviously infeasible. This invention describes a method which can be implemented for less than $2 and will meet the needs of an appliance to communicate with a master control appliance (such as a computer).

### TECHNICAL FIELD OF THE INVENTION

This invention relates generally to electronic communication and specifically to low cost communication via the power supply grid.

### BACKGROUND ART

The United States uses electrical power at 120V and 60 Hz. The idea of superimposing high frequency signals onto the electrical power is not new and is common knowledge. This high frequency content can be extracted from the power supply by using a high pass filter or a band pass filter. Suppose that you wish to extract a 10 MHz square pulse signal from the power supply. A high pass filter with a cutoff frequency of 10 MHz or a band pass filter allowing the frequency range of 10 MHz to 50 MHz would allow the 10 MHz square pulse signal through while blocking everything else.

Another feature of power supply lines is that they have a low inductance meaning that any high frequency signal applied to the power supply line will be detectable anywhere on the power supply line. The power supply is not like a transmission line, the signals do not travel in a single direction but rather in all directions.

Furthermore it has been speculated in many trade magazines that soon all electrical appliances will be connected to the internet. But in reality, the cost of giving an electrical appliance such as a refrigerator the ability to connect to the internet is much too high to be justified. This patent application suggests an alternate method for electrical appliances to communicate with a master control device such as a computer at a much lower cost.

### SUMMARY OF THE INVENTION

In this invention a low cost method is described for electrical and electronic appliances to communicate with a master control device (such as a computer) via the AC power supply. Each appliance contains a slave control device which ideally should always be supplied power even when the appliance is turned off. The master control device provides a periodic synchronization signal to which the slave control devices lock. Each slave control device is assigned two delays D1 and D2. At a delay D1 after the slave control device receives the periodic synchronization signal it can send a communication message to the master control device. At a delay D2 after the slave control device receives the periodic synchronization signal it can receive a communication message from the master control device.

### BEST MODE FOR CARRYING OUT THE INVENTION

Most if not all major electrical appliances are connected to the electrical power supply which supplies alternating current at 120V and 60 Hz. And they do have information we are interested in. A refrigerator could tell you what the temperatures in the upper and lower compartments are, a washing machine could tell you how many more minutes are required to complete it's cycle, a DVD player could tell you what is playing (useful if the kids are alone at home).

However these different types of information do not justify connecting the appliance to the internet as has been suggested in the trade magazines. The internet protocol is designed for exchanging much larger amounts of information and the cost of giving an electrical appliance such as a refrigerator the ability to connect to the internet is much too high to be justified. So this patent application describes a low cost method for electrical appliances to communicate with a master control device such as a computer.

Imagine the tower of babel. Everybody spoke at the same time in different languages. Nobody could understand each other and hence they were miserable. Now imagine the United Nations. Countries can talk to each other because they have interpreters. Now imagine a person called the “Master Control Device” who can understand all the languages of the United Nations. Assume that every hour he shouts out a synchronization message. When they hear the synchronization message different countries start counting out the seconds and when it is their turn they shout a message in their own language. Then they count off more seconds and when it is their turn they hear a response from the Master Control Device.

This patent application applies the method outlined above in an electrical fashion. It is crude but effective, and all the device needs to do is count out a delay after the synchronization signal and output their information or read the response. If as in claim 13, the periodic synchronization signal contains the duration between the periodic synchronization signal, then a delay locked loop (DLL) or a phase locked loop (PLL) could lock onto the periodic synchronization signal and provide timing accuracy for the delay.

In claim 2, the relationship between D1 and D2 could simply be that D2 occurs one maximum message duration before D1. When a device is connected to the power supply, it needs to obtain the D1 and D2, and it does this as in claim 3 and claim 4. When the appliance is disconnected the delays D1 and D2 are to be free for other appliances to use and this is done by claim 5. Since two appliances may be connected to the power supply at the same time there may be contention and this is resolved by claim 6.

Since bits may be dropped a method of determining the validity of a message is needed and this is covered in claim 7. There is really no requirement that all appliances use the same message format and this is covered in claim 8. In the simplest case the maximum allowed duration of the communication messages and the allowed delays may be derived from the periodicity of the synchronization signal and this is covered in claim 9. The periodicity of the synchronization signal could be variable and this is covered by claim 10. One reason to increase the duration between successive periodic synchronization signals is when new appliances are connected to the power supply and this is covered by claim 11.

As more devices are disconnected from the power supply, the assigned delays D1 and D2 may have to be changed and this is covered by claim 12. Aside from the assigned delays D1 and D2, there could is be another safeguard to ensure that the appliances be identified and this is covered in claim 14. A band pass filter would work as well as a high pass filter and this is covered by claim 15. Some devices have more information to transmit and this is covered by claim 16.

The master control device could save the communication messages for future use and this is covered by claim 17. The master control device could act as a gateway to the internet and this is covered in claim 18. Claim 19 covers the case when a delay locked loop (DLL) is used to calibrate the delays. Ideally the slave control device should always be connected to the power supply even when the appliance is switched off and it can be used to switch the appliance on and off and this is covered by claim 20.

What is claimed is:

1. A method of communication between electrical appliances and a master control device via the power supply grid comprising the apparatus and steps of:
connecting a master control device M to the power supply grid P via a high pass filter
sending of a periodic synchronization signal Q from the master control device M onto the power supply grid P
connecting an electrical appliance to the power supply grid P
connecting a slave control device S aboard the electrical appliance to the power supply grid P via a high pass filter
sending a communication message from the slave control device S onto the power supply grid P at a fixed delay D1 after each periodic synchronization signal Q from the master control device M
the master control device M receiving the communication message from the slave control device S via the power supply grid P
the slave control device S listening for and if present receiving a communication message from the master control device M via the power supply grid P at a fixed delay D2 after a periodic synchronization signal Q from the master control device M

2. The method of claim 1 wherein the fixed delay D2 bears a fixed relationship to the fixed delay D1, so that it can be determined from knowledge of the fixed delay D1

3. The method of claim 2 wherein the slave control device S determines the fixed delay D1 by listening at different delays after each periodic synchronization signal Q from the master control device M to find a delay not being used by any other electrical appliance and lays claim to usage of the fixed delay D1 by sending a communication message to the master control device M at that delay D1

4. The method of claim 3 wherein the master control device M confirms the claim of the slave control device S to usage of the fixed delay D1 by sending a confirmation communication message at the fixed delay D2 after a periodic synchronization signal Q from the master control device M

5. The method of claim 1 wherein the slave control device S loses claim to usage of the fixed delay D1 if it ceases to send communication messages to the master control device M at the fixed delay D1 after each periodic synchronization signal Q from the master control device M

6. The method of claim 4 wherein the master control device M resolves contention between two slave control devices laying claim to the same fixed delay D1 by not sending a confirmation communication message at the fixed delay D2 after a periodic synchronization signal Q from the master control device M

7. The method of claim 1 wherein the communication messages contain a checksum or other method of verifying that the message was received accurately and in it's entirety

8. The method of claim 1 wherein each electrical appliance uses a message format for it's communication message to the master control device M of it's own choosing so long as the master control device M is able to interpret the communication message

9. The method of claim 1 wherein the maximum duration of the communication messages and the allowed values for the fixed delays D1 and D2 bear a fixed relationship to the delay from the beginning of each periodic synchronization signal Q from the master control device M to the beginning of the next periodic synchronization signal Q from the master control device M

10. The method of claim 1 wherein the delay from the beginning of each periodic synchronization signal Q from the master control device M to the beginning of the next periodic synchronization signal Q from the master control device M is variable and the slave control devices are required to maintain their allotted fixed delays D1 and D2 to the periodic synchronization signal Q from the master control device M

11. The method of claim 1 wherein the delay from the beginning of each periodic synchronization signal Q from the master control device M to the beginning of the next periodic synchronization signal Q from the master control device M is increased as more devices are connected to the power supply grid P and decreased as more devices are disconnected from the power supply grid P

12. The method of claim 1 wherein the master control device M changes the fixed delays D1 and D2 of a slave control device by informing the slave control device of the change by sending it a communication message

13. The method of claim 1 wherein the periodic synchronization signal Q from the master control device M additionally contains information such as the allowed maximum duration of the communication messages or the duration between the periodic synchronization signals Q

14. The method of claim 3 wherein the message from the slave control device S contains an identification name for the slave control device S which identification name is also used in communication messages from the master control device M to the said slave control device S

15. The method of claim 1 wherein the high pass filter is replaced by a band pass filter

16. The method of claim 1 wherein some slave control devices are allotted more than one pair of fixed delays D1 and D2

17. The method of claim 1 wherein the master control appliance saves the information received from the slave control devices in non-volatile storage.

18. The method of claim 1 wherein the master control appliance re-transmits the information received from the slave control devices onto the internet and re-transmits the information received from the internet to specific slave control devices

19. The method of claim 1 wherein the slave control device uses the periodic synchronization signal Q from the master control device M to calibrate it's timing such as by the use of a delay locked loop (DLL).

20. The method of claim 1 wherein the slave-control device S remains active even when the electrical appliance is switched off, so that it can switch on the electrical appliance if a communication message is received from the master control device M and switch off the electrical appliance if a communication message is received from the master control device M
